(19) United States
(12) Patent Application Publication
(10) Pub. No.: US 2026/0269120 A1
(43) Pub. Date: Sep. 10, 2026

(54) VOLTAGE REGULATOR MODULE AND SEMICONDUCTOR COMBINATION

(71) Applicant: MetaPWR Electronics Co., Ltd., Shanghai (CN)

(72) Inventors: Mingzhun ZHANG, Shanghai (CN); Xiaoni Xin, Shanghai (CN); Yahong Xiong, Shanghai (CN)

(73) Assignee: MetaPWR Electronics Co., Ltd., Shanghai (CN)

(21) Appl. No.: 19/558,455

(22) Filed: Mar. 6, 2026

(30) Foreign Application Priority Data
Mar. 7, 2025 (CN) 202510269861.8

(51) Int. Cl. H01F 27/29; H01F 27/24; H01F 27/40; H02M 3/00

(52) U.S. Cl. CPC H01F 27/29; H01F 27/24; H01F 27/40; H02M 3/003

(57) ABSTRACT

The present disclosure discloses a structure of a voltage regulator module and a semiconductor combination. The input capacitor is arranged on the bottom surface of the top substrate. By optimizing the layout of the semiconductor combination and optimizing the setting of the power electrical connector, the parasitic parameters of the Voltage regulator module are further reduced, and the conversion efficiency of the voltage regulator module is improved; furthermore, the size of the voltage regulator module is reduced, and the working reliability of the voltage regulator module is improved.

### CROSS-REFERENCE TO RELATED APPLICATIONS

This application claims the priority benefit of China application no. 202510269861.8 filed on Mar. 7, 2025. The entirety of each of the above–mentioned patent applications is hereby incorporated by reference herein and made a part of this specification.

### BACKGROUND

In recent years, with the development of technologies such as data center, artificial intelligence, and supercomputers, more and more powerful ASICs are used to obtain applications, such as CPU, GPU, TPU, NPU, ML, AI accelerator, network switch, server, etc. which consume a large amount of current, such as thousands of amperes; and these ASICs have higher and higher dynamic response requirements for power supply. This load is conventionally supplied using a Voltage Regulator Module (VRM). With the advancement of the semiconductor technology, the power supply power of the ASIC is further increased, and the power supply voltage required by the ASIC is increasingly low. Therefore, the power supply current of the ASIC continues to increase. As the power supply current of the ASIC increases, the output power and the output current of the VRM also increase; and the improvement of the conversion efficiency of the VRM becomes a key to improving the power of the VRM. On the other hand, as the power density requirement continues to increase, the size of the voltage regulator module is required to be smaller and smaller. Therefore, the improvement of the size of the voltage regulator module, the improvement of the conversion efficiency, and the reliability of the voltage regulator module are the technical problems faced in the art.

### SUMMARY

In view of the above, one of the objectives of the disclosure is to provide a voltage regulator module, comprising:

a top assembly and an inductor assembly,

the inductor assembly comprises a magnetic core, a winding, and an electrical connector,

the magnetic core comprises a groove, a top surface and a bottom surface opposite to each other, a first side surface and a third side surface opposite to each other, and a second side surface and a fourth side surface opposite to each other, the groove is disposed on the top surface of the magnetic core and is recessed from the top surface,

wherein the winding comprises a first end and a second end, the first end protrudes from a bottom surface of the groove, and the second end is exposed on the bottom surface of the magnetic core,

the electrical connector comprises a first power electrical connector and a second power electrical connector, the first power electrical connector and the second signal electrical connector are alternately disposed at the side of the magnetic core,

the top assembly is disposed on a top surface of the inductor assembly, and the top assembly comprises a top substrate, an input capacitor, and a semiconductor combination, the semiconductor combination is disposed on the top substrate, the first end of the winding is electrically connected to the semiconductor combination by means of a top substrate, the input capacitor is accommodated in the groove, and the input capacitor is electrically connected to the semiconductor combination through the top substrate.

Preferably, the electrical connector is "C"-shaped, and covers a part of the top surface of the magnetic core, a part of a side surface of the magnetic core, and a part of the bottom surface of the magnetic core.

Preferably, the first power electrical connector is disposed on the first side surface and the third side surface of the magnetic core, the second power electrical connector is disposed on the first side surface and the third side surface of the magnetic core.

Preferably, the voltage regulator module, further comprising a signal electrical connector, wherein the signal electrical connector is disposed at the side of the magnetic core.

Preferably, the signal electrical connector comprises a first signal electrical connector and a second signal electrical connector, the first electrical connector is disposed on the second side surface of the magnetic core, and the second electrical connector is disposed on the fourth side surface of the magnetic core.

Preferably, the winding comprises a first winding and a second winding, wherein the first winding and the second winding are in an "I"-shaped or a "Z"-shaped,

the "Z"-shaped winding comprises a first vertical section, a horizontal section, and a second vertical section, the first vertical section of the first winding and the second vertical section of the second winding are arranged adjacent to the first side surface of the magnetic core, the second vertical section of the first winding and the first vertical section of the second winding are arranged adjacent to the third side surface of the magnetic core, the horizontal section of the first winding and the horizontal section of the second winding are arranged in parallel.

A semiconductor combination, comprising a logic control region, a silicon wafer region, a logic pin, an input positive pin, a ground pin, and a switch pin,

the silicon wafer region comprises a first silicon wafer region and a second silicon wafer region, each of the first silicon wafer region and the second silicon wafer region is provided with the input positive pin, the ground pin, and the switch pin,

each of the first silicon wafer region and the second silicon wafer region comprises an upper switch and a lower switch, the upper switch and the lower switch are electrically connected to the switch pin, and the upper switch and the lower switch are connected in series and then connected between the input positive pin and the ground pin,

the logic control region is provided with the logic pin, wherein the logic control region provides a driving signal to the first silicon wafer region and the second silicon wafer region.

Preferably, the first silicon wafer region and the second silicon wafer region are arranged side by side along a same side of the logic control region, and the upper switch of each silicon wafer region is disposed between the logic control region and the lower switch.

Preferably, the first silicon wafer region is disposed between the logic control region and the second silicon wafer region, the upper switch of the first silicon wafer region is disposed adjacent to the logic control region, and the lower switch of the first silicon wafer region and the lower switch of the second silicon wafer region are disposed adjacent to each other.

Preferably, the logic control region is disposed between the first silicon wafer region and the second silicon wafer region, the upper switch and the lower switch of each of the silicon wafer regions are disposed along one side of the logic control region, the upper switch of each of the silicon wafer regions is disposed adjacent to a same side of the semiconductor combination, or the upper switch of the first silicon wafer region and the lower switch of the second silicon wafer region are disposed adjacent to a same side of the semiconductor combination.

Preferably, in the same silicon wafer region, an area of the switch pin is greater than an area of the input positive pin, and/or an area of the ground pin is greater than the area of the input positive pin.

Preferably, in the same silicon wafer region, the switch pin and the input positive pin are alternately arranged, and/or the switch pin and the ground pin are alternately arranged.

Preferably, the first silicon wafer region and the second silicon wafer region share the input positive pin, and/or the first silicon wafer region and the second silicon wafer region share the ground pin.

Preferably, the input positive pin of the first silicon wafer region and the input positive pin of the second silicon wafer region are both disposed adjacent to the logic control region, the switch pin and the input positive pin are alternately arranged, and the switch pin and the ground pin are alternately arranged.

Preferably, the first silicon wafer region and the second silicon wafer region share a common ground pin, and the common ground pin is located at a boundary of the first silicon wafer region and the second silicon wafer region.

Preferably, the input positive pin of the first silicon wafer region is disposed adjacent to the logic control region, and the input positive pin of the second silicon wafer region is disposed away from the first silicon wafer region, the input positive pin, the switch pin, and the ground pin of the first silicon wafer region are sequentially arranged according to the input positive pin, the switch pin, the ground pin, the switch pin, and the common ground pin, the input positive pin, the switch pin, and the ground pin of the second silicon wafer region are sequentially arranged according to the input positive pin, the switch pin, the ground pin, the switch pin, and the common ground pin.

Preferably, the logic control region is stacked with the first silicon wafer region and/or the second silicon wafer region; projections of the logic control region and the first silicon wafer region on a same horizontal plane are at least partially overlapped, and/or projections of the logic control region and the second silicon wafer region on a same horizontal plane at least partially overlap.

Preferably, an interposer and a through silicon via are disposed between the logic control region and the first silicon wafer region and/or the second silicon wafer region, and the through silicon via is disposed through the interposer, the logic control region is electrically connected to the first silicon wafer region and/or the second silicon wafer region through the through silicon via.

Preferably, the logic control region is disposed between the first silicon wafer region and the second silicon wafer region, in the same silicon wafer region, the input positive pin and the switch pin are alternately arranged, and the ground pin and the switch pin are alternately arranged, the input positive pin of the first silicon wafer region and the input positive pin of the second silicon wafer region are both disposed adjacent to a same side of the semiconductor combination, or both the input positive pin of the first silicon wafer region and the ground pin of the second silicon wafer region are disposed adjacent to a same side of the semiconductor combination.

A voltage regulator module, comprising atop assembly and an inductor assembly, the top assembly is disposed on a top surface of the inductor assembly, the top assembly includes a top substrate and the voltage regulator module; the voltage regulator module is disposed on the top substrate; and the inductor assembly is electrically connected to the semiconductor combination through the top substrate.

Preferably, the top assembly further comprises an input capacitor, other passive components and a plastic package, the other passive components are disposed on two opposite sides of the semiconductor combination, and the plastic package is disposed on a top surface of the top substrate and encapsulates the semiconductor combination and the other passive components.

Preferably, the inductor assembly comprises a magnetic core, a winding, and an electrical connector,

the magnetic core comprises a top surface, a bottom surface, a first side surface and a third side surface opposite to each other, and a second side surface and a fourth side surface opposite to each other, a groove is recessed in the top surface and/or the bottom surface of the magnetic core,

the winding comprises a first winding and a second winding, and a first end of the first winding and a first end of the second winding are electrically connected to the semiconductor combination by means of the top substrate,

the electrical connector comprises a first power electrical connector, and a second power electrical connector; the first power electrical connector and the second power electrical connector are alternately disposed at the side of magnetic core.

Preferably, the voltage regulator module, further comprises a first signal electrical connector and a second signal electrical connector, wherein the first signal electrical connector is disposed on the second side surface of the magnetic core, and the second signal electrical connector is disposed on the fourth side surface of the magnetic core, the first power electrical connector is disposed on the first side surface and the third side surface of the magnetic core, the second power electrical connector is disposed on the first side surface and the third side surface of the magnetic core.

Preferably, the voltage regulator module, further comprising a bottom assembly, wherein the bottom assembly comprises a bottom substrate and an output capacitor, the winding and the electrical connector are electrically connected to the bottom substrate, and power and signals are transmitted between the bottom assembly and the top assembly by means of the winding and the electrical connector.

Compared with the prior art, the disclosure has the following beneficial effects:
(1) The present disclosure provides a voltage regulator module, which reduces the parasitic parameters of the inductor assembly by optimizing the arrangement of the electrical connectors.
(2) The present disclosure further provides a structure of a voltage regulator module. The input capacitor is arranged on the bottom surface of the top substrate, the output capacitor is arranged on the top surface of the bottom substrate, the top surface and the bottom surface of the inductor assembly are provided with grooves, and the grooves are used for accommodating the input capacitor or the output capacitor. Further, the parasitic parameters of the voltage regulator module are further reduced, and the conversion efficiency of the voltage regulator module is improved; furthermore, the size of the voltage regulator module is further reduced, and the working reliability of the voltage regulator module is improved.
(3) The present disclose further provides a semiconductor combination. By integrating the two switch bridge arms in the same semiconductor combination, the size of the semiconductor combination is reduced by controlling the two switch bridge arms with the same logic control region, thereby improving the performance of the semiconductor combination.

### DESCRIPTION OF DRAWINGS

FIG. 1A-1D are one embodiment of a voltage regulator module;

FIG. 2A to FIG. 2C are another embodiment of a voltage regulator module;

FIG. 3A to FIG. 3F are an integrated manner of a semiconductor combination.

### DETAILED DESCRIPTION

One of the cores of the present disclosure is to provide a high-efficiency voltage regulator module and a semiconductor combination.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

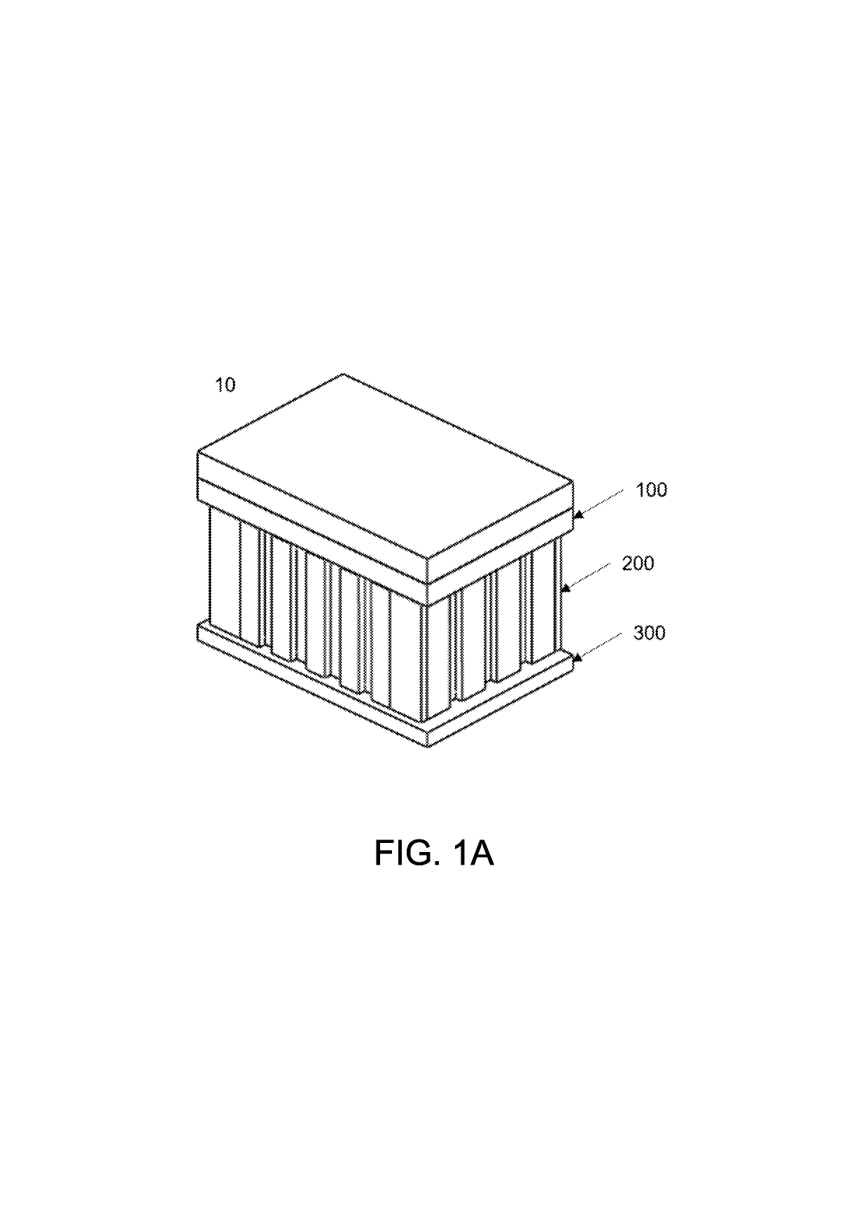

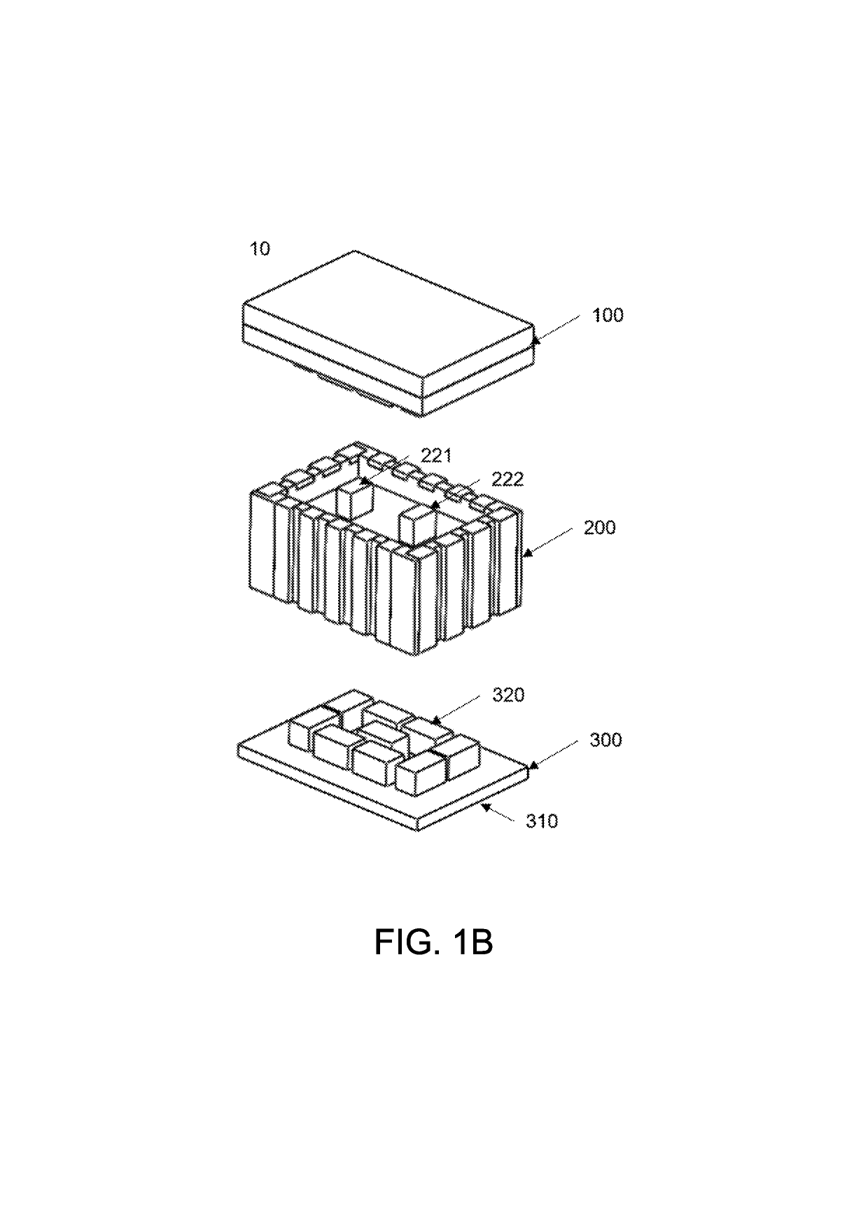

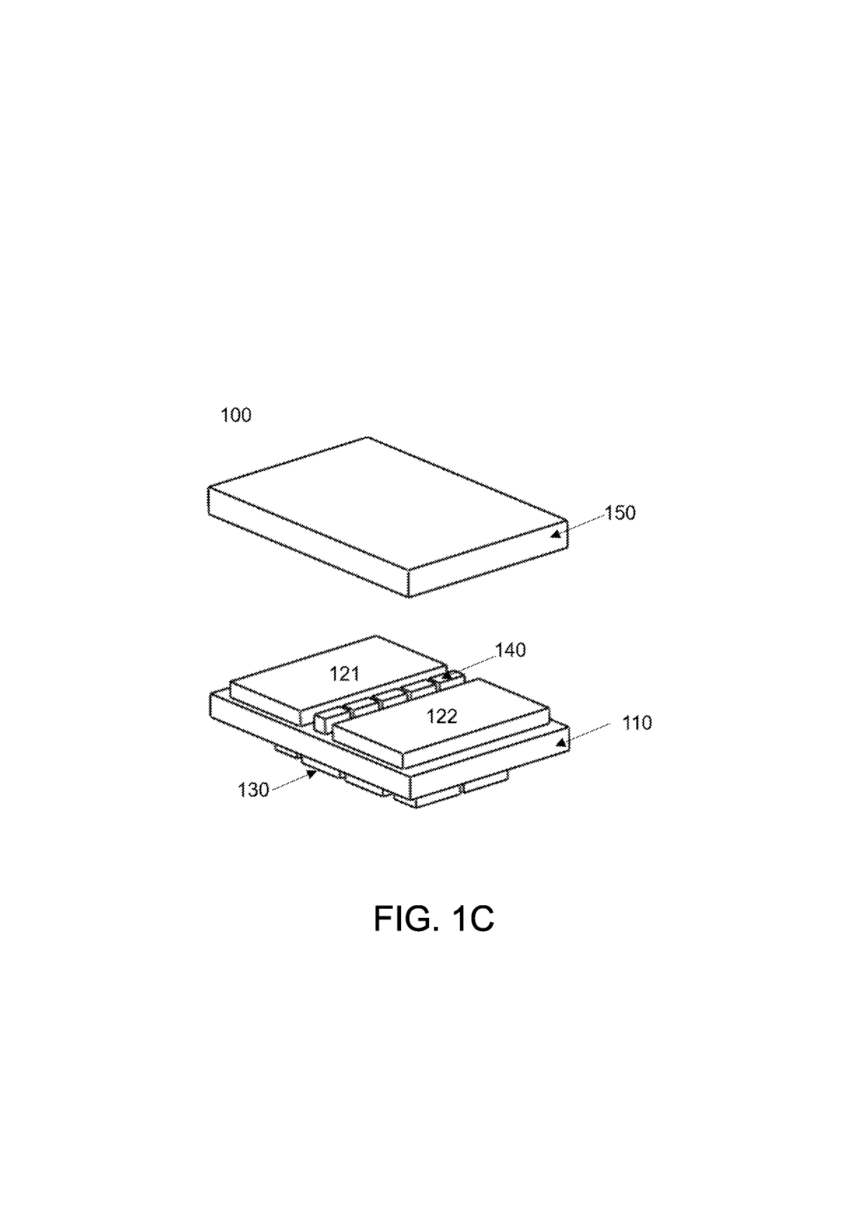

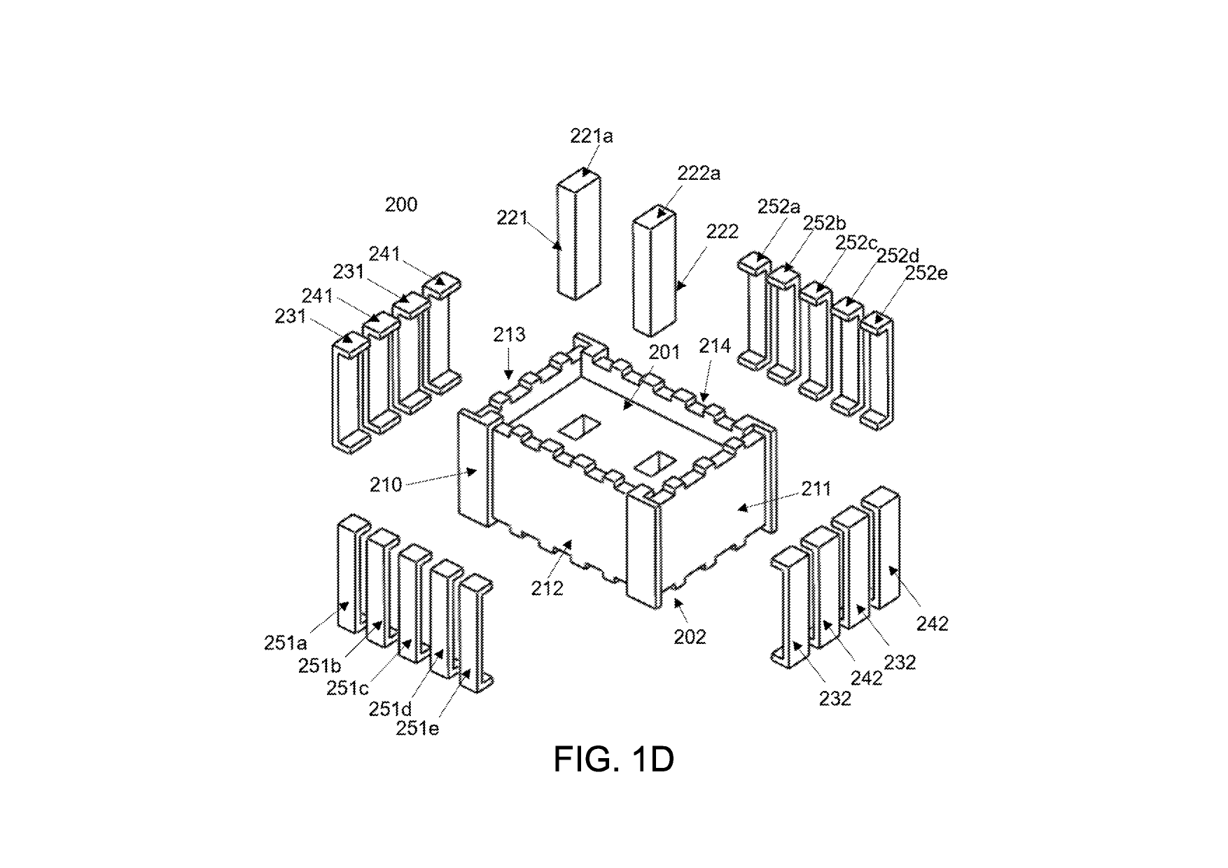

The present disclosure provides a voltage regulator module, as shown in FIG. 1A, which is a schematic diagram of a two-phase voltage regulator module, and FIG. 1B is an exploded view of the structure of FIG. 1A. With reference to FIGS. 1A and 1B, the voltage regulator module 10 comprises a top assembly 100, an inductor assembly 200 and a bottom assembly 300. FIG. 1C showing a structural exploded view of the top assembly 100. The top assembly 100 comprising a top substrate 110, a first semiconductor combination 121, a second semiconductor combination 122, an input capacitor 130 and other passive components 140. The first semiconductor combination 121 and the second semiconductor combination 122 being horizontally arranged on a top surface of the top substrate 110 and electrically connected to the top substrate 110. Other passive elements 140 are disposed on the top surface of the top substrate and disposed between the two semiconductor combinations. The input capacitor 130 is disposed on a bottom surface of the top substrate and is electrically connected to the top substrate. The semiconductor combination 121 & 122 and the other passive elements 140 are molded together by molding compound 150, thereby protecting the semiconductor combination and the passive element. In this embodiment, the semiconductor combination 121/122 may be a Driver MOSFET (Dr. MOS for short); however, it is not limited thereto. The bottom assembly comprises a bottom substrate 310 and an output capacitor 320, the output capacitor 320 is provided on a top surface of the bottom substrate 310, and a bottom surface of the bottom substrate 310 is provided with connection portions (not shown); the connection portions are configured to be electrically connected to an external component, and transmit power and/or signals.

FIG. 1D is a structural exploded view of the inductor assembly 200. The inductor assembly 200 comprises a magnetic core 210, a first winding 221, a second winding 222, a first power electrical connector 231 & 232, a second power electrical connector 241 & 242, a first signal electrical connector 251 and a second signal electrical connector 252. The magnetic core 210 comprises a top surface and a bottom surface opposite to each other, a first side surface 211 and a third side surface 213 opposite to each other, a second side surface 212 and a fourth side surface 214 opposite to each other. A groove 201 is provided on the top surface of the magnetic core 210, and is recessed in the top surface of the magnetic core, and is used for accommodating the input capacitor 130. A groove 202 is arranged on the bottom surface of the magnetic core 210, and is recessed from the bottom surface of the magnetic core, and is used for accommodating the output capacitor 320. Both the first winding 221 and the second winding 222 are "I"-shaped; the first winding and the second winding penetrate through the bottom surface of the groove 201 and the bottom surface of the groove 202, and both the first ends and the second ends of the first winding and the second winding protrude from the bottom surfaces of the grooves 201 & 202. A first end surface 221a of the first winding and a first end surface 222a of the second winding are electrically connected to the semiconductor combination 121 & 122 by means of the top substrate 110, which is in detail electrically connected to a SW pin of the semiconductor component. The "I"-shaped winding can achieve a minimum DC impedance, thereby further improving the conversion efficiency of the voltage regulator module.

The first power electrical connector 231 and the second power electrical connector 241 are disposed on the third side surface 213 of the magnetic core and are alternately arranged at intervals. The first power electrical connector 232 and the second power electrical connector 242 are disposed on the first side surface 211 of the magnetic core and are alternately arranged at intervals. In the present embodiment, the first power electrical connector may be a Vin+ electrical connector, and is electrically connected to an input positive terminal of the voltage regulator module; and the second power electrical connector may be a GND electrical connector electrically connected to a GND end of the voltage regulator module. The first power electrical connector and the second power electrical connector are alternately arranged at intervals to reduce parasitic inductance between the first power electrical connector and the second power electrical connector (the parasitic inductance and the input capacitance of the voltage regulator module generate LC oscillations), so that the oscillation frequency is far away from the switching frequency of the voltage regulator module, thereby reducing the oscillation voltage and reducing the interference of the oscillation voltage to the voltage regulator module. The first signal electrical connector is disposed on the second side surface 212 of the magnetic core, and comprises a plurality of metal members 251a, 251b, 251c, 251d and 251e; the second signal electrical connector is disposed on the fourth side surface 214 of the magnetic core, and comprises a plurality of metal members 252a, 252b, 252c, 252d and 251e. The signal electrical connectors can transmit signals, and the signals can be control signals or sampling signals or other signals. In addition, at least part of the signal electrical connectors can also be used as an analog ground AGND or a power ground PGND, thereby reducing the area of the signal loop and reducing the noise and interference of the signal loop coupling.

In other embodiments, the groove may also be provided only on the top surface of the magnetic core, or the groove is provided only on the bottom surface of the magnetic core.

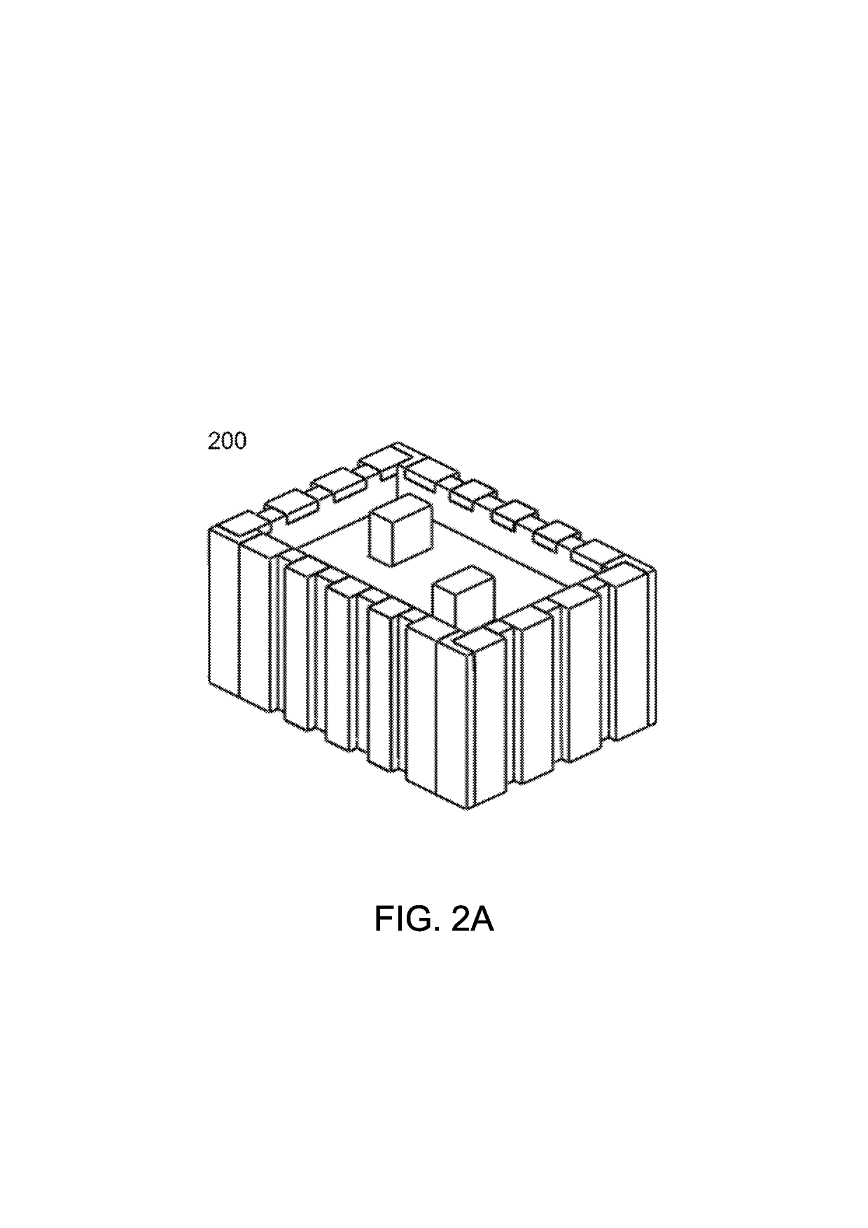

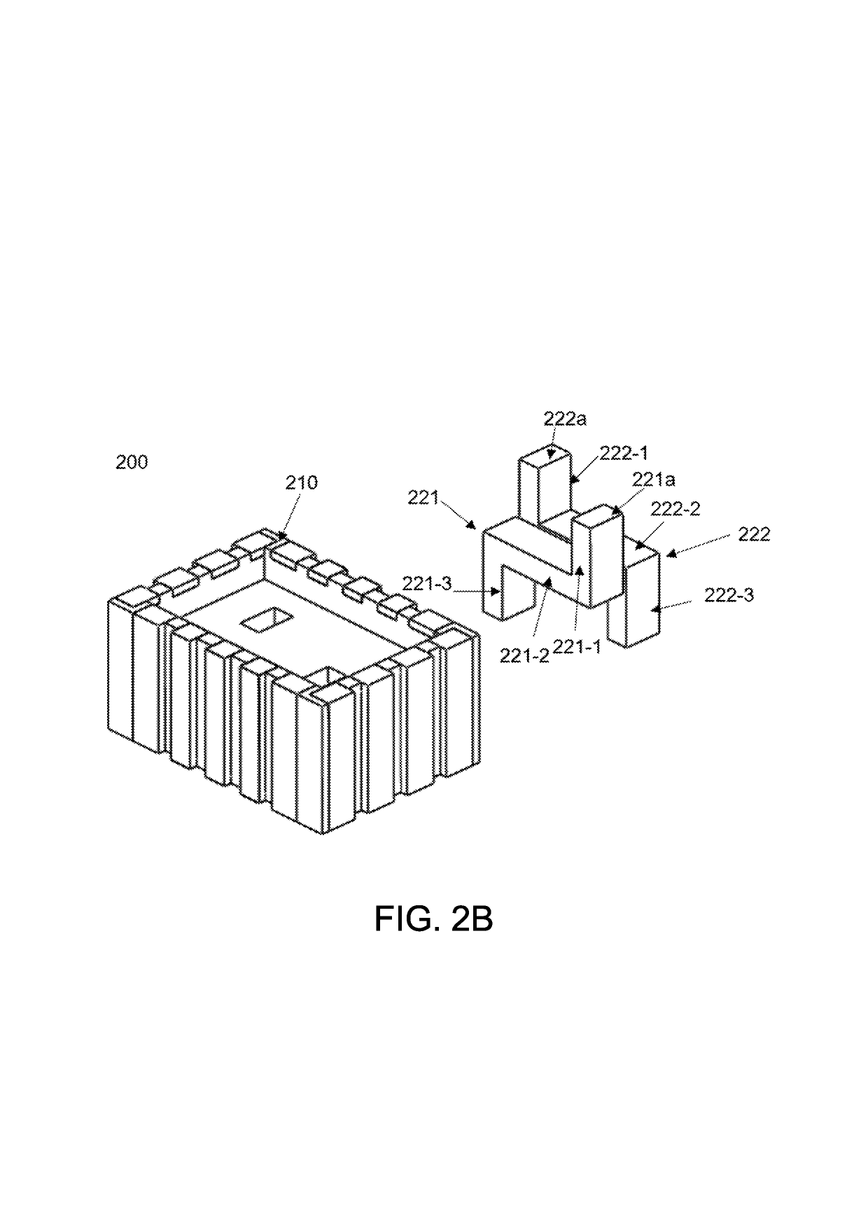

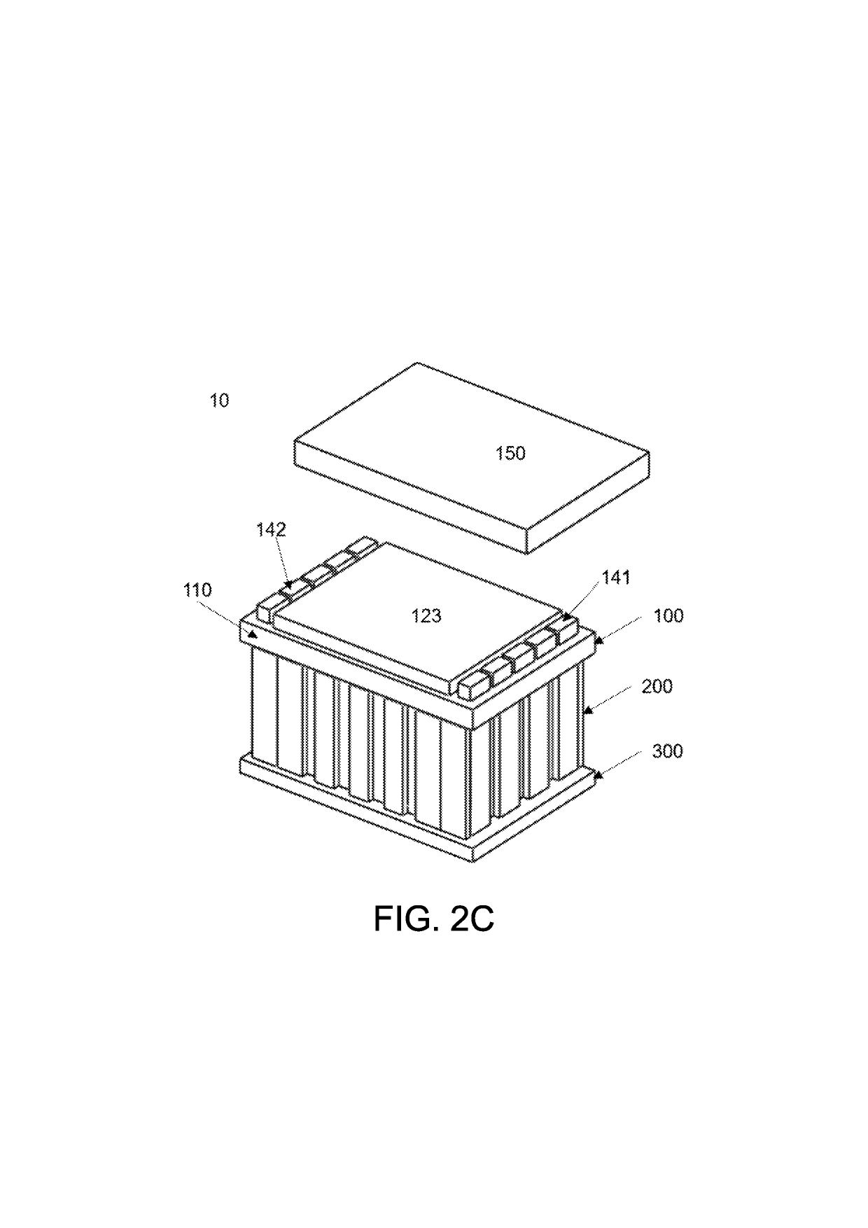

FIG. 2A is another preferred embodiment of the inductor assembly 200, and FIG. 2B is an exploded view of the inductor assembly 200. The difference in the embodiment shown in FIG. 2A and 1D is the winding shape. As shown in FIG. 2A, the first winding 221 and the second winding 222 are "Z"-shaped; the first winding 221 comprises a first vertical section 221-1, a horizontal section 221-2, and a second vertical section 221-3; the second winding 222 comprises a first vertical section 222-1, the horizontal section 222-2 and the second vertical section 222-3. The horizontal sections 221-2 and 222-2 are arranged in parallel and adjacent to each other so as to increase the coupling between the first winding and the second winding; the first vertical section 222-1 and the second vertical section 221-3 are disposed adjacent to the third side surface of the magnetic core, and the first vertical section 221-1 and the second vertical section 222-3 are disposed adjacent to the first side surface of the magnetic core. Therefore, the first vertical segments 221-1 and 222-1 are disposed away from each other, and the second vertical segments 221-3 and 222-3 are disposed away from each other. The first end surface 221a of the first winding 221 and the first end surface 222a of the second winding 222 are respectively electrically connected to the SW pins of the semiconductor combination 121 and 122 by means of the top substrate 110; and the current in the inductor winding flows from the first end surface of the winding, and the inductor operates in the reverse coupling state. The reverse-coupling inductance can achieve a low dynamic inductance, and can achieve a high steady-state inductance, so that the voltage regulator module obtains a fast dynamic response and a high conversion efficiency.

FIG. 2C is another embodiment of the top assembly 100, the difference between this embodiment and the embodiment shown in FIG. 1A is that the semiconductor combination 123, the semiconductor combination 123 comprises two Dr. MOS. Other passive elements 141 & 142 are provided on opposite sides of the semiconductor combination 123. Other passive elements 140, 141 and 142 may each be provided as a high frequency input capacitor for reducing the path of the input high frequency loop.

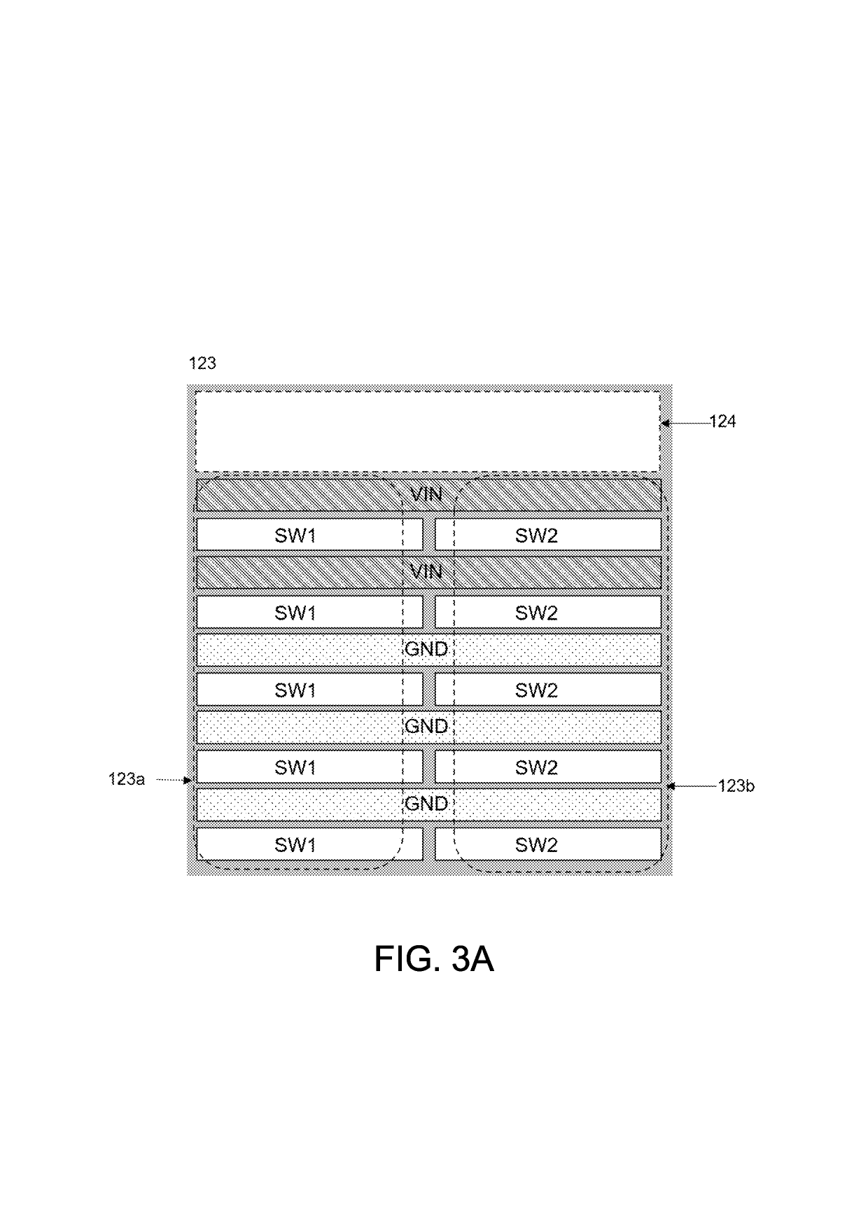

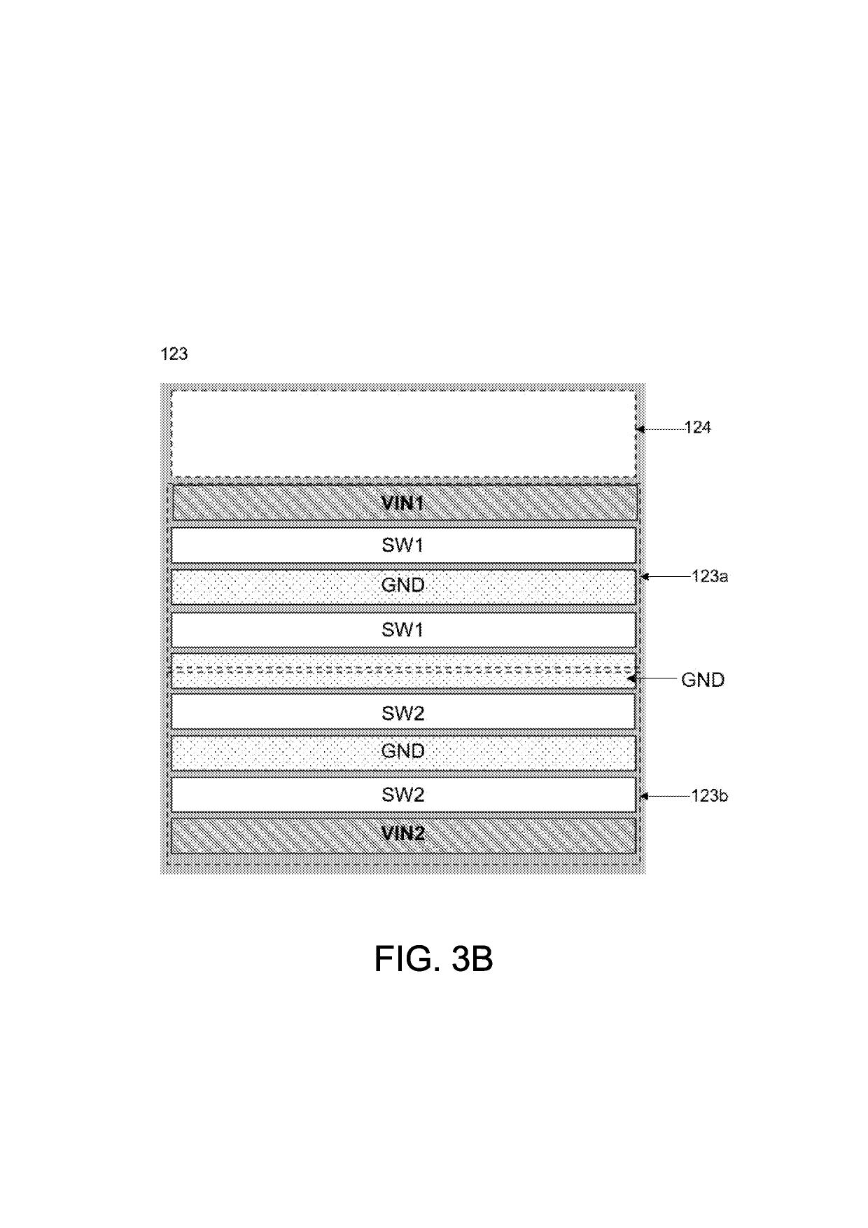

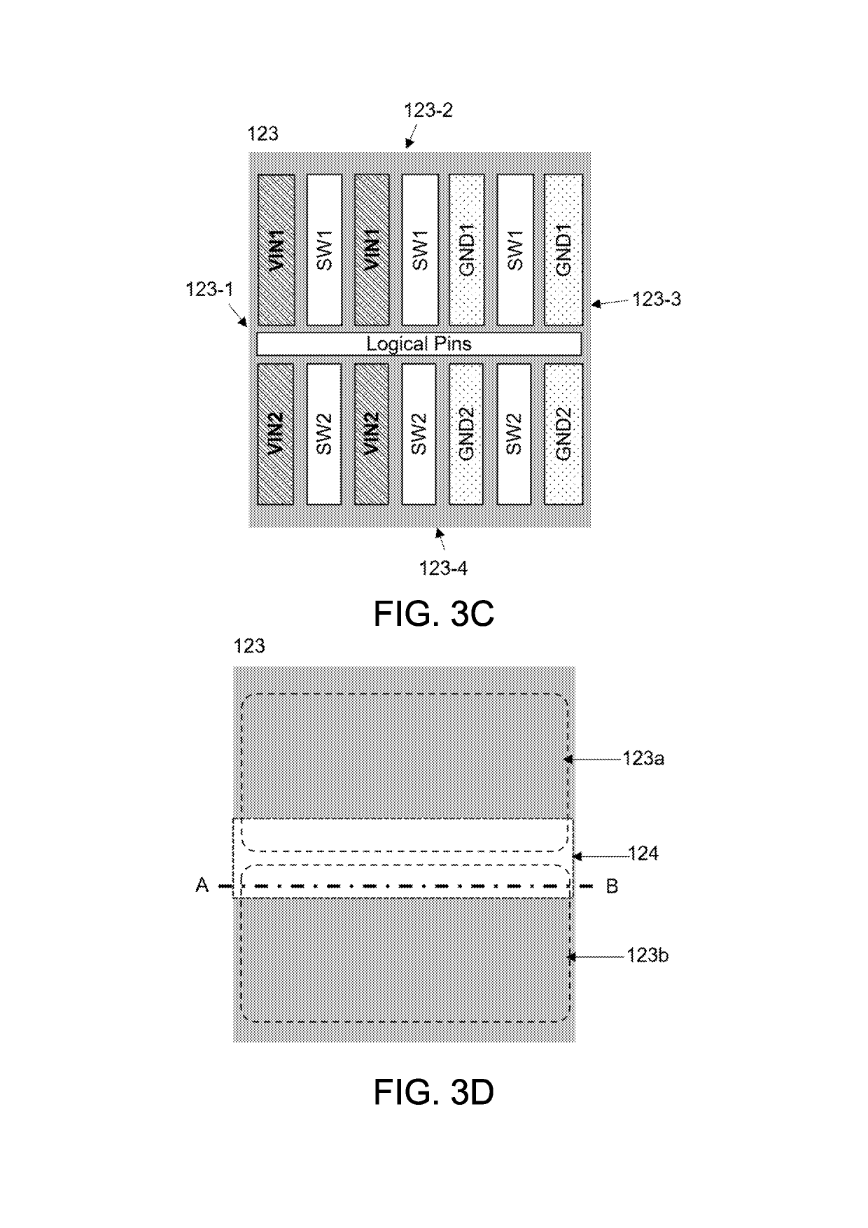

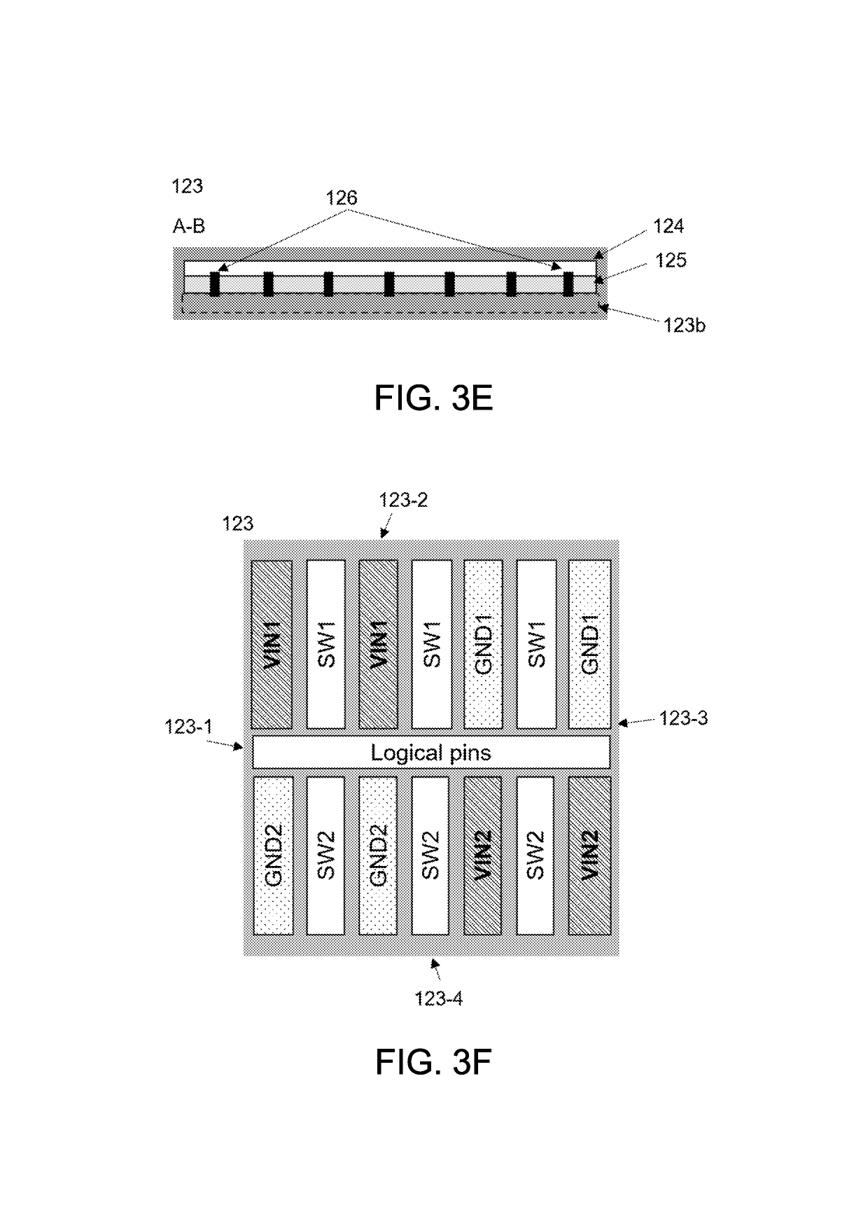

An integrated manner of the semiconductor combination 123 is also disclosed, as shown in FIG. 3A-3F. FIG. 3A is an integrated manner, a logic control region 124 is arranged along one side of the semiconductor combination, and logical pins are arranged in the logic control region (not shown); a first silicon wafer region 123a and a second silicon wafer region 123b are arranged side by side along one side of the logic control region 124. An upper switch and a lower switch are provided in each silicon wafer region as an example for description. The upper switch and the lower switch are electrically connected in series. In each silicon wafer region, the upper switch is disposed adjacent to the logic control region 124, that is, the upper switch is disposed between the logic control region and the lower switch. A drain electrode of each upper switch is electrically connected to an input positive pin VIN, and a source electrode of each lower switch is electrically connected to a ground pin GND; a source electrode of the upper switch and a drain electrode of the lower switch in the first silicon wafer region 123a are electrically connected to a switch pin SW1, a source electrode of the upper switch and a drain electrode of the lower switch in the second silicon wafer region 123b are electrically connected to a switch pin SW2. The input positive pin VIN and the switch pin SW in the power pins are alternately arranged, and the ground pin GND and the switch pin SW are alternately arranged. In this way, parasitic parameters are reduced, and the reliability of the semiconductor combination is improved. In addition, because the current flowing through the switch pin SW and the ground pin GND is relatively large, the area of the switch pin SW is greater than the area of the input positive pin VIN, and the area of the ground pin GND is greater than the area of the input positive pin VIN. The input positive pin VIN in the first silicon wafer region 123a is connected to the input positive pin VIN in the second silicon wafer region 123b, the ground pin GND in the first silicon wafer region 123a is connected to the ground pin GND in the second silicon wafer region 123b, the parasitic impedance of the semiconductor combination is further reduced, and the conversion efficiency of the voltage regulator module is improved.

FIG. 3B illustrates another integrated manner of the semiconductor combination 123, the logic control region 124 being provided the same as that shown in FIG. 3A except that the first silicon wafer region 123a is disposed between the logic control region 124 and the second silicon wafer region 123b. An upper switch and a lower switch are provided in each silicon wafer region being taken as an example for description, and the upper switch and the lower switch are electrically connected in series. In the first silicon wafer region 123a, the upper switch is disposed adjacent to the logic control region 124; the lower switch of the first silicon wafer region is adjacent to the lower switch of the second silicon wafer region 123b, and the upper switch of the second silicon wafer region 123b and the logic control region 124 are respectively disposed adjacent to two opposite sides of the semiconductor combination 123. The drain electrode of each upper switch is electrically connected to the input positive pin VIN, and the source electrode of each lower switch is electrically connected to the ground pin GND; the source electrode of the upper switch and the drain electrode of the lower switch in the first silicon wafer region 123a are electrically connected to the switch pin SW1,;the source of the upper switch and the drain of the lower switch in the second silicon wafer region 123b are electrically connected to the switch pin SW2. Among the power pins, the switch pin SW is disposed between the input positive pin VIN and the ground pin GND, and/or is disposed between the two ground pins GND; in detail, the power pins are arranged in an order of, the input positive pin VIN, the switch pin SW, the ground pin GND, the switch pin SW, and the ground pin GND. At a boundary of the first silicon wafer region 123a and the second silicon wafer region 123b, the two silicon wafer regions share a common ground pin GND. In this way, the parasitic impedance of the semiconductor combination is further reduced, and the conversion efficiency of the voltage regulator module is improved.

FIG. 3C to FIG. 3E show another integration manner of the semiconductor combination 123, FIG. 3C is a pin layout of the semiconductor combination 123, FIG. 3D is a layout diagram of the silicon wafer region, and FIG. 3E is a side cross-sectional view of the semiconductor combination. As shown in FIG. 3C and FIG. 3D, the logic control region 124 is disposed between the first silicon wafer region 123a and the second silicon wafer region 123b; the upper switch in each silicon wafer region is disposed adjacent to a first side 123-1 of the semiconductor combination, and the lower switch in each silicon wafer region is disposed adjacent to a third side 123-3 of the semiconductor combination. In each silicon wafer region, the connection between the upper switch and the lower switch is the same as that in the foregoing embodiment, except that the logical pins are disposed between the pins of the first silicon wafer region 123a and the pins of the second silicon wafer region 123b; the switch pin SW may be disposed between the input positive pin VIN and the ground pin GND, and the switch pin SW may be disposed between the two ground pins GND. The switch pin SW may also be disposed between the two input positive pins VIN. An input positive pin VIN is disposed adjacent to the first side 123-1, and a ground pin GND is disposed adjacent to the third side 123-3. The pin layout method can also obtain the technical effect of reducing the parasitic impedance of the semiconductor combination and improving the conversion efficiency of the voltage regulator module.

FIG. 3D shows a layout of a silicon wafer region in a semiconductor combination. In this embodiment, the logic control region 124 is stacked with the silicon wafer region 123a and/or 123b, and projections of the logic control region 124 and the first silicon wafer region 123a on the same horizontal plane are at least partially overlapped, and projections of the logic control region 124 and the second silicon wafer region 123b on the same horizontal plane at least partially overlap. Along A-B shown in FIG. 3D, that is, as shown in FIG. 3E, an interposer 125 and through silicon vias (TSVs) 126 are provided between the logic control region 124 and the second silicon wafer region 123b. The through silicon via 126 penetrates through the interposer 125 and the logic control region 124 and the silicon wafer region are electrically connected by means of the through silicon via 126. Similarly, the logic control region 124 and the first silicon wafer region may be electrically connected by means of the through silicon via 126. The stacking technology shown in this embodiment can further increase the area of the silicon wafer region, which helps to reduce the on-state impedance between the drain electrode and the source electrode of the power switch, and help improve the conversion efficiency of the Voltage regulator module. The logic control region 124 is arranged above the silicon wafer region, thereby shortening the path between the driving/control signal and the power switch, greatly reducing the delay of turning-on or turning-off caused by the long path, and eliminating the problem of non-synchronization on-off caused by the path difference between the driving/control signal and different power switches; further reducing the loss of the power switch and improving the conversion efficiency of the voltage regulator module; and further reducing EMI interference and improving the stability of the voltage regulator module. Furthermore, the use of the interposer is advantageous to eliminate stress problems between the logic control region and the silicon wafer region due to differences in coefficient of thermal expansion.

FIG. 3F illustrates another embodiment of the semiconductor combination 123 different from FIG. 3C in that the upper switch of the first silicon wafer region 123a is disposed adjacent to the first side 123-1, the lower switch of the first silicon wafer region 123a is disposed adjacent to the third side 123-3; the upper switch of the second silicon wafer region 123b is disposed adjacent to the third side 123-3, and the lower switch of the second silicon wafer region 123b is disposed adjacent to the first side 123-1. The arrangement of the input positive pin VIN, the switch pin SW, and the ground pin GND is the same as that of FIG. 3C, except that an input positive pin VIN in the second silicon wafer region is disposed adjacent to the third side 123-3, and the ground pin GND is disposed adjacent to the first side 123-1. This embodiment can also obtain the same technical effect as shown in FIG. 3C, and details are not described herein again.

The switch tube disclosed by the application can be used for realizing the functions of the switch disclosed by the application such as a Si MOSFET□SiC MOSFET□GaN MOSFET or IGBT MOSFET.

The voltage regulator module according to the embodiment can be an independent module or a part of the electronic device, and can meet the technical features and advantages disclosed by the disclosure.

The " equal " or " same " or " equal to " disclosed by the application needs to consider the parameter distribution of engineering, and the error distribution is within +/-30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/-30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A voltage regulator module, comprising:
a top assembly and an inductor assembly,
wherein the inductor assembly comprises a magnetic core, a winding, and an electrical connector,
wherein the magnetic core comprises a groove, a top surface and a bottom surface opposite to each other, a first side surface and a third side surface opposite to each other, and a second side surface and a fourth side surface opposite to each other, the groove is disposed on the top surface of the magnetic core and is recessed from the top surface,
wherein the winding comprises a first end and a second end, the first end protrudes from a bottom surface of the groove, and the second end is exposed on the bottom surface of the magnetic core,
wherein the electrical connector comprises a first power electrical connector and a second power electrical connector, the first power electrical connector and the second signal electrical connector are alternately disposed at the side of the magnetic core,
wherein the top assembly is disposed on a top surface of the inductor assembly, and the top assembly comprises a top substrate, an input capacitor, and a semiconductor combination, the semiconductor combination is disposed on the top substrate, the first end of the winding is electrically connected to the semiconductor combination by means of a top substrate, the input capacitor is accommodated in the groove, and the input capacitor is electrically connected to the semiconductor combination through the top substrate.

2. The voltage regulator module of claim 1, wherein the electrical connector is "C"-shaped, and covers a part of the top surface of the magnetic core, a part of a side surface of the magnetic core, and a part of the bottom surface of the magnetic core.

3. The voltage regulator module of claim 1, wherein the first power electrical connector is disposed on the first side surface and the third side surface of the magnetic core, the second power electrical connector is disposed on the first side surface and the third side surface of the magnetic core.

4. The voltage regulator module of claim 1, further comprising a signal electrical connector, wherein the signal electrical connector is disposed at the side of the magnetic core.

5. The voltage regulator module of claim 4, wherein the signal electrical connector comprises a first signal electrical connector and a second signal electrical connector, the first electrical connector is disposed on the second side surface of the magnetic core, and the second electrical connector is disposed on the fourth side surface of the magnetic core.

6. The voltage regulator module of claim 1, wherein the winding comprises a first winding and a second winding, wherein the first winding and the second winding are in an "I"-shaped or a "Z"-shaped,
wherein the "Z"-shaped winding comprises a first vertical section, a horizontal section, and a second vertical section, the first vertical section of the first winding and the second vertical section of the second winding are arranged adjacent to the first side surface of the magnetic core, the second vertical section of the first winding and the first vertical section of the second winding are arranged adjacent to the third side surface of the magnetic core, the horizontal section of the first winding and the horizontal section of the second winding are arranged in parallel.

7. A semiconductor combination, comprising a logic control region, a silicon wafer region, a logic pin, an input positive pin, a ground pin, and a switch pin,
wherein the silicon wafer region comprises a first silicon wafer region and a second silicon wafer region, each of the first silicon wafer region and the second silicon wafer region is provided with the input positive pin, the ground pin, and the switch pin,
wherein each of the first silicon wafer region and the second silicon wafer region comprises an upper switch and a lower switch, the upper switch and the lower switch are electrically connected to the switch pin, and the upper switch and the lower switch are connected in series and then connected between the input positive pin and the ground pin,
wherein the logic control region is provided with the logic pin, wherein the logic control region provides a driving signal to the first silicon wafer region and the second silicon wafer region.

8. The semiconductor combination of claim 7, wherein the first silicon wafer region and the second silicon wafer region are arranged side by side along a same side of the logic control region, and the upper switch of each silicon wafer region is disposed between the logic control region and the lower switch.

9. The semiconductor combination of claim 7, wherein the first silicon wafer region is disposed between the logic control region and the second silicon wafer region, the upper switch of the first silicon wafer region is disposed adjacent to the logic control region, and the lower switch of the first silicon wafer region and the lower switch of the second silicon wafer region are disposed adjacent to each other.

10. The semiconductor combination of claim 7, wherein the logic control region is disposed between the first silicon wafer region and the second silicon wafer region, the upper switch and the lower switch of each of the silicon wafer regions are disposed along one side of the logic control region, the upper switch of each of the silicon wafer regions is disposed adjacent to a same side of the semiconductor combination, or the upper switch of the first silicon wafer region and the lower switch of the second silicon wafer region are disposed adjacent to a same side of the semiconductor combination.

11. The semiconductor combination of claim 7, wherein in the same silicon wafer region, an area of the switch pin is greater than an area of the input positive pin, and/or an area of the ground pin is greater than the area of the input positive pin.

12. The semiconductor combination of claim 7, wherein in the same silicon wafer region, the switch pin and the input positive pin are alternately arranged, and/or the switch pin and the ground pin are alternately arranged.

13. The semiconductor combination of claim 8, wherein the first silicon wafer region and the second silicon wafer region share the input positive pin, and/or the first silicon wafer region and the second silicon wafer region share the ground pin.

14. The semiconductor combination of claim 13, wherein the input positive pin of the first silicon wafer region and the input positive pin of the second silicon wafer region are both disposed adjacent to the logic control region, the switch pin and the input positive pin are alternately arranged, and the switch pin and the ground pin are alternately arranged.

15. The semiconductor combination of claim 9, wherein the first silicon wafer region and the second silicon wafer region share a common ground pin, and the common ground pin is located at a boundary of the first silicon wafer region and the second silicon wafer region.

16. The semiconductor combination of claim 15, wherein the input positive pin of the first silicon wafer region is disposed adjacent to the logic control region, and the input positive pin of the second silicon wafer region is disposed away from the first silicon wafer region, the input positive pin, the switch pin, and the ground pin of the first silicon wafer region are sequentially arranged according to the input positive pin, the switch pin, the ground pin, the switch pin, and the common ground pin, the input positive pin, the switch pin, and the ground pin of the second silicon wafer region are sequentially arranged according to the input positive pin, the switch pin, the ground pin, the switch pin, and the common ground pin.

17. The semiconductor combination of claim 7, wherein the logic control region is stacked with the first silicon wafer region and/or the second silicon wafer region; projections of the logic control region and the first silicon wafer region on a same horizontal plane are at least partially overlapped, and/or projections of the logic control region and the second silicon wafer region on a same horizontal plane at least partially overlap.

18. The semiconductor combination of claim 17, wherein an interposer and a through silicon via are disposed between the logic control region and the first silicon wafer region and/or the second silicon wafer region, and the through silicon via is disposed through the interposer, the logic control region is electrically connected to the first silicon wafer region and/or the second silicon wafer region through the through silicon via.

19. The semiconductor combination of claim 7, wherein the logic control region is disposed between the first silicon wafer region and the second silicon wafer region, in the same silicon wafer region, the input positive pin and the switch pin are alternately arranged, and the ground pin and the switch pin are alternately arranged, the input positive pin of the first silicon wafer region and the input positive pin of the second silicon wafer region are both disposed adjacent to a same side of the semiconductor combination, or both the input positive pin of the first silicon wafer region and the ground pin of the second silicon wafer region are disposed adjacent to a same side of the semiconductor combination.

20. A voltage regulator module, comprising atop assembly and an inductor assembly, the top assembly is disposed on a top surface of the inductor assembly, the top assembly includes a top substrate and the voltage regulator module of claim 4; the voltage regulator module is disposed on the top substrate; and the inductor assembly is electrically connected to the semiconductor combination through the top substrate.

21. The voltage regulator module of claim 20, wherein the top assembly further comprises an input capacitor, other passive components and a plastic package, the other passive components are disposed on two opposite sides of the semiconductor combination, and the plastic package is disposed on a top surface of the top substrate and encapsulates the semiconductor combination and the other passive components.

22. The voltage regulator module of claim 20, wherein the inductor assembly comprises a magnetic core, a winding, and an electrical connector,
wherein the magnetic core comprises a top surface, a bottom surface, a first side surface and a third side surface opposite to each other, and a second side surface and a fourth side surface opposite to each other, a groove is recessed in the top surface and/or the bottom surface of the magnetic core,
wherein the winding comprises a first winding and a second winding, and a first end of the first winding and a first end of the second winding are electrically connected to the semiconductor combination by means of the top substrate,
wherein the electrical connector comprises a first power electrical connector, and a second power electrical connector; the first power electrical connector and the second power electrical connector are alternately disposed at the side of magnetic core.

23. The voltage regulator module of claim 22, further comprises a first signal electrical connector and a second signal electrical connector, wherein the first signal electrical connector is disposed on the second side surface of the magnetic core, and the second signal electrical connector is disposed on the fourth side surface of the magnetic core, the first power electrical connector is disposed on the first side surface and the third side surface of the magnetic core, the second power electrical connector is disposed on the first side surface and the third side surface of the magnetic core.

24. The voltage regulator module of claim 22, further comprising a bottom assembly, wherein the bottom assembly comprises a bottom substrate and an output capacitor, the winding and the electrical connector are electrically connected to the bottom substrate, and power and signals are transmitted between the bottom assembly and the top assembly by means of the winding and the electrical connector.
